(19) United States
(12) Patent Application Publication
(10) Pub. No.: US 2018/0060308 A1
(43) Pub. Date: Mar. 1, 2018

(54) METHOD AND APPARATUS FOR MESSAGE COMMUNICATION

(71) Applicant: Beijing Xiaomi Mobile Software Co., Ltd., Beijing (CN)

(72) Inventors: Ming LIU, Beijing (CN); Liangxiong WU, Beijing (CN); Yanfei LUO, Beijing (CN)

(21) Appl. No.: 15/686,242

(22) Filed: Aug. 25, 2017

Related U.S. Application Data
(63) Continuation of application No. PCT/CN2016/097720, filed on Aug. 31, 2016.

(51) Int. Cl. G06F 17/27; G06F 17/24

(52) U.S. Cl. CPC G06F 17/2785; G06F 17/24; G06F 17/276; G06F 17/2775

(57) ABSTRACT

A method for message communication, includes: acquiring a communication message sent by a current contact in a communication application, the communication application having a messaging function; determining a message type which matches the communication message; acquiring at least one candidate word for replying to the communication message, in accordance with the message type; and displaying the at least one candidate word.

### CROSS-REFERENCE TO RELATED APPLICATION

This application is based upon and claims priority to International Application No. PCT/CN2016/097720, filed on Aug. 31, 2016, the entire contents of which are incorporated herein by reference.

### TECHNICAL FIELD

The present application generally relates to the technical field of communications, and more particularly, to a method and apparatus for message communication.

### BACKGROUND

Applications (APPs) having a messaging function, such as short message service (SMS) APPs, instant messenger APPs, and social networking APPs, may be installed in a terminal device such as a mobile phone or a tablet PC. Users can communicate with each other via such APPs.

Taking the SMS APP as an example, when a user sends a short message, the SMS APP will invoke an inputting method APP. The user then uses the inputting method APP to input a coded string. The inputting method APP generates at least one candidate word corresponding to the coded string in accordance with a code matching rule, and displays the candidate word. For example, in a Chinese pinyin inputting method, when the coded string inputted by the user is “shouji,” the Chinese pinyin inputting method APP will generate candidate words, such as “sh\check{o}u jī” (which means “mobile phone” in English), “shōu ji” (which means “collect” in English),” “sh\check{o}u ji” (which means “essays” in English) and “shōu ji” (which means “send-receive” in English), for the user to select therefrom. After a desired candidate word is selected by the user, the selected candidate word will be inputted into an input box of the SMS APP. After the user completes editing a short message in the input box, the short message can be sent out via the SMS APP.

### SUMMARY

According to a first aspect of the present disclosure, there is provided a method for message communication, comprising: acquiring a communication message sent by a current contact in a communication application, the communication application having a messaging function; determining a message type which matches the communication message; acquiring at least one candidate word for replying to the communication message, in accordance with the message type; and displaying the at least one candidate word.

According to a second aspect of the present disclosure, there is provided an apparatus for message communication, comprising: a processor; and a memory storing instructions executable by the processor. The processor is configured to: acquire a communication message sent by a current contact in a communication application, the communication application having a messaging function; determine a message type which matches the communication message; acquire at least one candidate word for replying to the communication message, in accordance with the message type; and display the at least one candidate word.

According to a third aspect of the present disclosure, there is provided a non-transitory computer-readable storage medium having stored therein instructions that, when executed by a processor of a mobile terminal, cause the mobile terminal to perform a message communicating method, the method comprising: acquiring a communication message sent by a current contact in a communication application, the communication application having a messaging function; determining a message type which matches the communication message; acquiring at least one candidate word for replying to the communication message, in accordance with the message type; and displaying the at least one candidate word.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flowchart of a method for message communication according to an exemplary embodiment.

FIG. 2 is a flowchart of a method for message communication according to another exemplary embodiment.

FIG. 3 is a schematic diagram of an interface of an inputting method APP according to an exemplary embodiment.

FIG. 4 is a block diagram of an apparatus for message communication according to an exemplary embodiment.

FIG. 5 is a block diagram of an apparatus for message communication according to another exemplary embodiment.

FIG. 6 is a block diagram of an apparatus according to an exemplary embodiment.

### DETAILED DESCRIPTION

Reference will now be made in detail to certain exemplary embodiments, examples of which are illustrated in the accompanying drawings. The following description refers to the accompanying drawings in which the same numbers in different figures represent the same or similar elements unless otherwise indicated. The implementations set forth in the following description of embodiments do not represent all implementations consistent with the disclosure. Instead, they are merely examples of apparatuses and methods consistent with aspects related to the disclosure as recited in the appended claims.

Embodiments of the present disclosure provide a method and an apparatus for message communication, so as to solve the problems in the related conventional art. Specifically, in exemplary embodiments, an inputting method APP, acquires a communication message sent by a current contact of a communication App, and at least one candidate word is generated automatically in accordance with the communication message, so that a number of operations to be performed by a user when replying to the communication message is reduced and the efficiency for generating candidate words is improved.

In exemplary embodiments of the present disclosure, the disclosed method may be performed by a terminal, such as a mobile phone, a tablet, a computer, etc. For example, an inputting method APP is installed and runs in the terminal, and the disclosed method may be performed by the inputting method APP. For illustration purpose only, an inputting method APP for inputting Chinese language is used to describe the disclosed method, but the disclosed method is not limited to Chinese language.

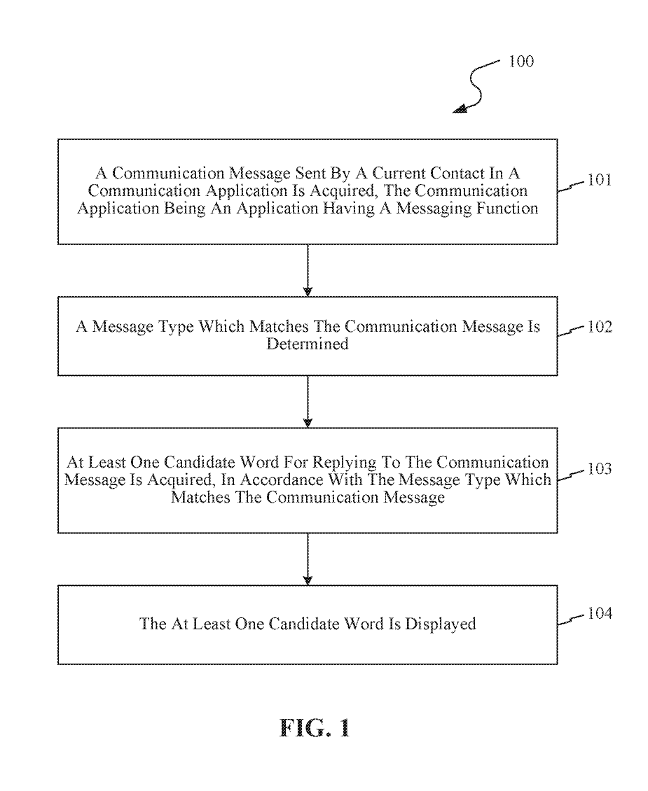

FIG. 1 is a flowchart of a method 100 for message communication according to an exemplary embodiment. The method 100 may comprise the following steps.

At step 101, a communication message sent by a current contact in a communication application is acquired, the communication application being an application having a messaging function.

At step 102, a message type which matches the communication message is determined.

At step 103, at least one candidate word for replying to the communication message is acquired, in accordance with the message type which matches the communication message.

At step 104, the at least one candidate word is displayed.

In the method 100, a communication message sent by a current contact in a communication application is acquired, a message type which matches the communication message is determined, and at least one candidate word for replying to the communication message is acquired in accordance with the determined message type. The method 100 solves the problem in the related conventional art that the efficiency for generating candidate words by an inputting method APP is low. The method 100 further, automatically generates at least one candidate word for replying to the communication message, after a communication message is received. Accordingly, the number of operations to be performed by the user in replying to the communication message is reduced and the efficiency for generating candidate words is improved, thereby improving the efficiency of replying to the communication message.

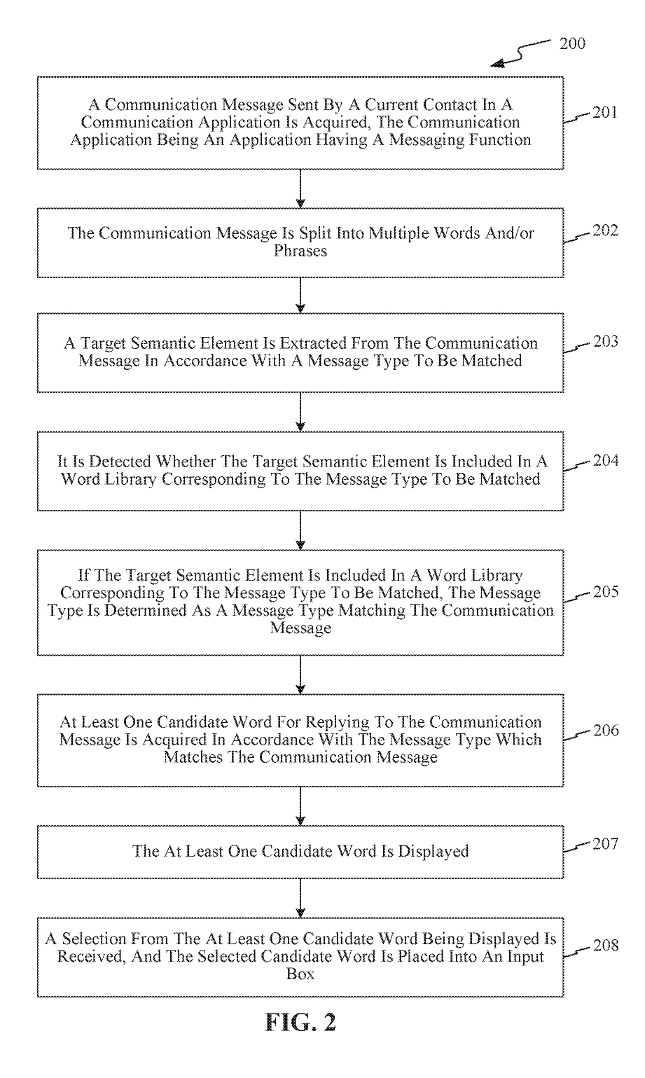

FIG. 2 is a flowchart of a method 200 for message communication according to another exemplary embodiment. For example, the method 200 may be used in an inputting method APP which is installed and runs in a terminal. The method 200 may comprise the following steps.

At step 201, a communication message sent by a current contact in a communication application is acquired, the communication application being an application having a messaging function.

In the present disclosure, the communication application is not limited to a specific type. The communication application may be any APP having a messaging function. For example, the communication application may be a SMS APP, an instant messenger APP, a social networking APP, a payment APP, a shopping APP or the like. The communication message refers to a message sent or received by the communication application. For example, the communication message may be a short message, an instant communication message, a session message, a notification message, etc.

In the present disclosure, the timing when the inputting method APP acquires the communication message is not limited. In an exemplary embodiment, when the communication application is displaying a session interface, a communication message sent by a current contact corresponding to the session interface is acquired. Before being invoked by the communication application, the inputting method APP may have generated corresponding candidate word(s) based on the acquired communication message, thereby improving the quickness of displaying the candidate words. In another exemplary embodiment, the inputting method APP acquires a communication message sent by a current contact in the communication application, when invoked by the communication application. That is, when the terminal detects an inputting behavior in the communication application, the inputting method APP will acquire the communication message sent by the current contact in the communication application. As a user may only need to read the communication message in the current session interface but does not need to reply to the communication message in the session interface, sometimes it may be a waste of processing resources of the terminal if the inputting method APP generates candidate words before being invoked. Thus, in the exemplary embodiment, the terminal can be prevented from performing unnecessary operations, and processing resources of the terminal can be saved.

In the present disclosure, the scenario in which the inputting method APP acquires the communication message is not limited. In an exemplary embodiment, when the session interface being displayed by the communication application is a single chat session interface, the current contact is a contact in the single chat session. Accordingly, the inputting method APP acquires a communication message sent by the current contact in the communication application during the single chat session. In another exemplary embodiment, when the session interface being displayed by the communication application is a group chat session interface, the current contact is at least one contact of the group chat session. Accordingly, the inputting method APP acquires a communication message sent by the current contact in the communication application during the group chat session.

In some embodiments, the communication message may refer to the last n communication messages sent by the current contact, wherein n is an integer equal to or greater than 1. Given that the user usually replies to the last communication message sent by the current contact, corresponding candidate words for reply may be determined based on the last communication message, thereby improving accuracy of the generated candidate words and better meeting the user's needs. In addition, considering that a contact may send multiple communication messages continuously and that the communication message which needs to be replied to by the user may not be the last one (for example, may be the second-to-last one), determination of corresponding candidate words based on the last few communication messages sent by the current contact facilitates improving comprehensiveness and usability of the generated candidate words.

After the inputting method APP acquires the communication message, a message type which matches the communication message will be determined by the following steps 202 to 205. In the present disclosure, the communication message may be categorized into a variety of different message types, which may include but are not limited to at least one of a noun-selection type, a verb-selection type, a question type, and a particular type. The noun-selection type refers a type of communication message for selecting a noun, such as “ni yao man tou, hai yao hua juan?” (which means ‘Do you want steamed buns or steamed rolls?’ in English), “xia jie shi shu xue ke, hai shi yu wen ke?” (which means “Is the next class a math or Chinese class?” in English), “min tian shi qing tian, hai shi duo yun?” (which means “Is tomorrow a sunny day or a cloudy day?” in English), etc. The verb-selection type refers to a type of communication message for making a selection with respect to a verb, such as “mang bu?” (which means “Are you busy?” in English), “chi le mei?” (which means “Have you eaten?” in English), “yao bu yao?” (which means “Do you want it?” in English), etc. The question type refers to a type of communication message for questioning, for example a communication message that ends with a modal particle expressing an questioning mood, such as “ma,” “me,” “ne,” “a” or “la” (which are modal particles in Chinese). The particular type refers to a type of communication message including a preset specific semantic element, for example a communication message including a specific semantic element such as “xie xie” (which means “Thanks” in English), “sheng ri kuai le” (which means “Happy birthday” in English), “xin nian hao” (which means “Happy new year” in English). The above message types are merely exemplary. Many other different message types may be set according to actual needs.

At step 202, the communication message is split into multiple semantic elements, such as multiple words and/or multiple phrases.

The inputting method APP may use a word segmentation algorithm to split the communication message into multiple semantic elements. The semantic elements include words and/or phrases. For example, if the communication message is “chi fan le mo?” (which means “Have you eaten yet?” in English), the semantic elements as a result of the splitting may include “chi fan,” “le,” and “mo.”

At step 203, a target semantic element is extracted from the communication message in accordance with a message type to be matched.

The target semantic element is used for determining the message type which matches the communication message. In an exemplary embodiment, the message type to be matched may include any of the following: a noun-selection type, a verb-selection type, a question type, and a particular type. The manner for the inputting method APP to extract a target semantic element from the communication message varies with the message type to be matched. In some embodiments, the step 203 may comprise the following sub-steps.

Firstly, a part-of-speech for each of the semantic elements is determined.

Secondly, the target semantic element is extracted from the communication message, in accordance with a semantic element extraction rule corresponding to the message type to be matched and the part-of-speech for each of the multiple semantic elements.

The semantic element extraction rule prescribes a part-of-speech feature of the target semantic element to be extracted from the communication message.

By way of example, when the message type to be matched is a noun-selection type, the corresponding semantic element extraction rule is to extract an adverb before a noun. For example, when the communication message is “ni yao man tou, hai yao hua juan?”, the communication message will be split into multiple semantic elements including “ni”, “yao”, “man tou”, “hai yao”, “hua juan”. The part-of-speech of each of the foregoing semantic elements is a possessive pronoun, an adverb, a noun, an adverb and a noun, respectively. When a semantic element extraction rule corresponding to the noun-selection type is used, the extracted target semantic elements are “yao” and “hai yao”.

When the message type to be matched is a verb-selection type, the corresponding semantic element extraction rule is to extract a verb phrase. For example, the verb phrase may be a phrase composed of verb and adverb, a phrase composed of verb plus “le (which is a modal particle in Chinese)” and adverb, or a phrase composed of verb plus adverb and verb (the two verbs before and after the adverb are the same). For example, when the communication message is “ni chi bu chi xi gua” (which means “Do you eat watermelon or not” in English), the communication message will be split into multiple semantic elements including “ni”, “chi”, “bu”, “chi”, “xi gua”. The part-of-speech of each of the foregoing semantic elements is a possessive pronoun, a verb, an adverb, a verb, and a noun, respectively. When a semantic element extraction rule corresponding to the verb-selection type is used, the extracted target semantic elements are “chi” and “bu chi.”

When the message type to be matched is a question type, the corresponding semantic element extraction rule is to extract a modal particle. Alternatively, the corresponding semantic element extraction rule prescribes that the last modal particle in the communication message is extracted. For example, when the communication message is “zhi dao wo jia zai na ma” (which means “Do you know where my home is” in English), “ma” will be extracted as the target semantic element according to the semantic element extraction rule corresponding to the question type.

When the message type to be matched is a particular type, the semantic element extraction rule is to detect whether a preset specific semantic element exists in the communication message and to extract the preset specific semantic element, if any, as the target semantic element. For example, a specific semantic element library is set in advance, including specific semantic elements such as “xie xie,” “sheng ri kuai le,” “jie ri kuai le” (which means “Happy holidays” in English), “wo ai ni” (which means “I love you” in English). “xin nian hao” and etc. When the communication message is “lao po, wo ai ni” (which means “I love you, my wife” in English). “I love you” will be extracted as the target semantic element according to the semantic element extraction rule corresponding to the particular type.

At step 204, it is detected whether the target semantic element is included in a word library corresponding to the message type to be matched.

A corresponding word library is set for each message type, and each word library includes some semantic elements.

At step 205, if the target semantic element is included in the word library corresponding to the message type to be matched, the message type is determined as a message type matching the communication message.

For example, when the message type to be matched is a verb-selection type, the target semantic element extracted from the communication message “ni chi bu chi xi gua” is “chi bu chi”. If “chi bu chi” is included in the word library corresponding to the verb-selection type, it is determined that the verb-selection type matches the communication message. If “chi bu chi” is not included in the word library corresponding to the verb-selection type, it is determined that the verb-selection type does not match the communication message.

In some embodiments, when a plurality of different message types are set in advance, an inputting method APP may perform, for various message types to be matched, parallel processing or serial processing to determine a message type which matches the communication message. When the serial processing is performed, processing priorities among the various message types to be matched may be set, and the message types to be matched can be processed sequentially according to a descending order of the processing priorities.

At step 206, at least one candidate word for replying to the communication message is acquired, in accordance with the message type which matches the communication message.

In some embodiments, when the message type which matches the communication message is a noun-selection type, a noun indicated by the target semantic element will be extracted from the communication message wherein the target semantic element is acquired by extracting from the communication message in accordance with the noun-selection type (its corresponding semantic element extraction rule). In this case, the at least one candidate word for replying to the communication message includes the extracted noun. The noun indicated by the target semantic element refers to a noun which is after the target semantic element and is the nearest one from the target semantic element. For example, when the communication message is “ni yao man tou, hai yao huajuan?”, the target semantic elements is “yao” and “hai yao”. The nouns indicated by the target semantic elements include “man tou” and “hua juan”. Thus, candidate words for replying to the communication message include “man tou” and “hua juan”.

In some embodiments, the inputting method APP also generates a candidate word meaning selecting all or selecting none. Thus, the at least one candidate word for replying to the communication message also include the candidate word which means selecting all or selecting none. In an exemplary embodiment, the inputting method APP generates a candidate word meaning selecting all or selecting none, in accordance with an adverb or a verb included in the communication message. In another exemplary embodiment, the inputting method APP acquires a preset candidate word meaning selecting all or selecting none, which corresponds to the target semantic element. For example, when the communication message is “ni yao man tou, hai yao hua juan?”, candidate words for replying to the communication message also include “dou yao” (which means “I want both of them” in English) and “dou bu yao” (which means “I want none of them” in English).

In some embodiments, when the message type which matches the communication message is a verb-selection type, a verb will be extracted from the target semantic element and at least one candidate word for replying to the communication message will be determined based on the verb, wherein the target semantic element is acquired by extracting from the communication message in accordance with the verb-selection type (its corresponding semantic element extraction rule). In this case, the at least one candidate word for replying to the communication message includes at least one of the following: a positive tense form of the verb, a negative tense form of the verb, a perfect tense form of the verb and an imperfect tense form of the verb.

In the following Table-1, different forms of several verbs are shown by way of example.

TABLE 1

| | Positive tense form | Negative tense | Perfect tense form | Imperfect tense |
|---|---|---|---|---|
| Verb | of the verb | form of the verb | of the verb | form of the verb |
| Mang | Mang | Bu mang (meaning | / | / |
| (meaning | | “not busy” in | | |
| “busy” | | English) | | |
| in | | | | |
| English) | | | | |
| Chi | Chi | Bu chi (meaning | Chi le (meaning | Mei chi (meaning |
| (meaning | | “do not eat” in | “have eaten” in | “have not eaten” in |
| “eat” in | | English) | English) | English) |
| English) | | | | |
| Shui | Shui | Bu shui (meaning | Shui le (meaning | Mei shui (meaning |
| (meaning | | “do not sleep” in | “have slept” in | “have not slept” in |
| “sleep” | | English) | English) | English) |
| in | | | | |
| English) | | | | |
| Zhuo | Zhuo | Bu zhuo (meaning | Zhuo le (meaning | Mei zuo (meaning |
| (meaning | | “do not do” in | “have done” in | “have not done” in |
| “do” in | | English) | English) | English) |
| English) | | | | |

The positive tense form of the verb may be the verb itself, the negative tense form of the verb is typically formed by adding “bu” (which means “No” in English) before the verb, the perfect tense form of the verb is typically formed by adding “le” (which means “already done” in English) after the verb, and the imperfect tense form of the verb is typically formed by adding “mei” (which means “not yet” in English) before the verb.

For example, if a communication message is “Zhang san, ni chi le me” (meaning “Zhang san, have you eaten yet” in English), the message type which matches the communication message is a verb-selection type. The target semantic element extracted from the communication message is “chi le mo,” and the verb in the target semantic element is “chi.” Accordingly, candidate words for replying to the communication message may include “chi”, “bu chi”, “chi le” and “mei chi”.

In some embodiments, when the message type which matches the communication message is a question type, the nearest verb from the target semantic element will be extracted from the communication message, and at least one candidate word for replying to the communication message will be determined based on the verb, wherein the target semantic element is acquired by extracting from the communication message in accordance with the verb-selection type (its corresponding semantic element extraction rule). In this case, the at least one candidate word for replying to the communication message includes at least one of the following: a positive tense form of the verb, a negative tense form of the verb, a perfect tense form of the verb and an imperfect tense form of the verb.

For example, when a communication message is “zhi dao wo jia zai na ma,” the message type which matches it is a question type, the target semantic element extracted from the communication message is “ma,” and the verb nearest from the target semantic element is “zhi dao” (meaning “know” in English). Accordingly, the at least one candidate word for replying to the communication message may include: “zhi dao,” “bu zhi dao” (meaning “do not know” in English, “zhi dao le” (meaning “have known” in English) and “hai mei zhi dao” (meaning “have not known” in English).

In some embodiments, when the message type which matches the communication message is a particular type, at least one preset candidate word corresponding to the target semantic element will be acquired, wherein the target semantic element is acquired by extracting from the communication message in accordance with the particular type (its corresponding semantic element extraction rule). In this case, the at least one candidate word for replying to the communication message includes a candidate word corresponding to the target semantic element.

For each of specific semantic elements in the word library corresponding to the particular type, candidate words corresponding to the specific semantic element may be stored in advance. In the following Table-2, several specific semantic elements and corresponding candidate words are shown by way of example.

TABLE 2

| Specific semantic element | Candidate words |
|---|---|
| Xie xie | Bu ke qi, bu yong xie |
| | (meaning “You are |
| | welcome/Not at all” in |
| | English) |
| Huan ying (meaning | Xie xie |
| “Welcome” in English) | |
| Jie ri kuai le | Ye zhu ni jie ri kuai le |
| | (meaning “You too” in |
| | English) |
| Sheng ri kuai le | Xie xie |
| Gong xi fa cai (meaning | Gong xi fa cai |
| “Wish you prosperity” in | |
| English) | |

For example, if the communication message is “xie xie ni!” (meaning “Thank you!” in English), the message type which matches it is a particular type The target semantic element extracted from the communication message is “xie xie,” and candidate words corresponding to the target semantic element are “bu ke qi” and “bu yong xie.” Accordingly, candidate words for replying to the communication message may include “bu ke qi” and “bu yong xie.”

At step 207, the at least one candidate word is displayed.

After the inputting method APP determines candidate words for replying to the communication message and the communication application invokes the inputting method APP, the inputting method APP will display the candidate words in a candidate word displaying area.

In some embodiments, the inputting method APP will display the at least one candidate word for replying to the communication message in priority. For example, the inputting method APP displays the at least one candidate word for replying to the communication message on the first page of the candidate word displaying area and particularly near the start position of the first page, thereby facilitating improving the efficiency of replying to the communication message.

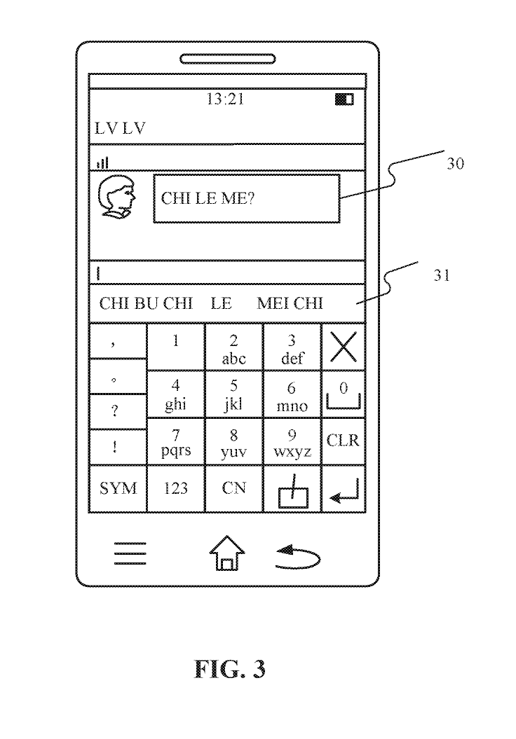

In an example, referring to FIG. 3, after the communication application receives the communication message “chi le me?” 30, the inputting method APP will display candidate words for replying to the communication message in a candidate word display area 31. The candidate words include “chi,” “bu chi,” “chi le” and “mei chi.”

It is to be noted that there may be one or more message types which match the communication message. When there are more than one message types which match the communication message, candidate words for replying to the communication message can be acquired based on each message type which matches the communication message, and all the candidate words acquired based on the more than one message types can be displayed.

At step 208, a selection from the at least one candidate word being displayed is received, and the selected candidate word is displayed in an input box.

A user may select, in the candidate word displaying area, a candidate word to be placed in the input box. Correspondingly, the inputting method APP will receive the selection from the at least one candidate word being displayed, and display the selected candidate word in the input box. Thus, the candidate word selected by the user is displayed in the input box of the communication application.

In some embodiments, if the candidate word desired by the user is not included in the at least one candidate word which is generated automatically by the inputting method APP for replying to the communication message, the user may input a coded string via the inputting method APP. Correspondingly, after receiving the coded string input by the user, the inputting method APP cancels displaying the at least one candidate word generated automatically for replying to the communication message, and generates candidate words corresponding to the coded string in accordance with a code matching rule and displays the generated candidate words.

Further, after the user completes editing in the input box a communication message to be sent, the edited communication message is sent to the current contact.

In this exemplary embodiment, the word library corresponding to each message type is stored locally in the terminal. In some embodiments, the word library corresponding to each message type may be stored in a server. The inputting method APP sends a communication message to the server, the server then generates at least one candidate word for replying to the communication message by matching and sends the at least one candidate word to the inputting method APP. The inputting method APP receives the at least one candidate word sent by the server and then displays it. By storing the word library corresponding to the message type in the terminal, it facilitates improving the speed of generating candidate words by the inputting method APP. On the other hand, by storing the word library corresponding to the message type in the server, it lowers requirements on processing and storage capabilities of the terminal. In practical applications, either way may be used according to the actual situation.

In the exemplary embodiment, a communication message sent by a current contact in a communication application is acquired, a message type which matches the communication message is determined, and at least one candidate word for replying to the communication message is acquired in accordance with the determined message type. The exemplary method provided by this embodiment solves the problem in the related conventional art that the efficiency for generating candidate words by an inputting method APP is low The exemplary method further provides automatically generating at least one candidate word for replying to the communication message after the communication message is received. Accordingly, the number of operations required to be performed by the user in replying to the communication message is reduced and the efficiency for generating candidate words is improved, thereby facilitating improving the efficiency of replying to the communication message.

Furthermore, by differentiating between message types and, setting different semantic element extraction rules and candidate word generation rules for different message types respectively, accuracy and usability of the generated candidate words can be improved.

In addition, because it is highly possible for a user to reply to the latest received one or more communication messages, generating corresponding candidate words based on the latest received one or more communication messages facilitates improving accuracy of the generated candidate words and better meeting the user's requirements.

Apparatus embodiments of the present disclosure, will be described in the following. The apparatus may be used to perform method embodiments of the present disclosure.

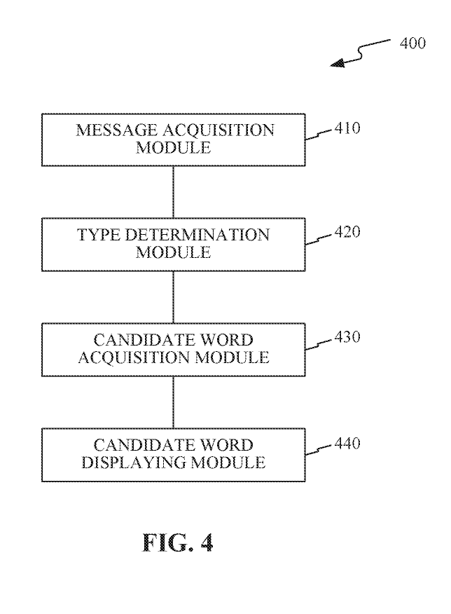

FIG. 4 is a block diagram of an apparatus 400 for message communication according to an exemplary embodiment. The apparatus 400 is capable of implementing the above methods by hardware or through running corresponding software. The apparatus 400 may comprise: a message acquisition module 410, a type determination module 420, a candidate word acquisition module 430 and a candidate word displaying module 440.

The message acquisition module 410 is configured to acquire a communication message sent by a current contact in a communication application. The communication application is an application having a messaging function.

The type determination module 420 is configured to determine a message type which matches the communication message acquired by the message acquisition module 410.

The candidate word acquisition module 430 is configured to acquire at least one candidate word for replying to the communication message, in accordance with the message type which matches the communication message determined by the type determination module 420.

The candidate word displaying module 440 is configured to display the at least one candidate word acquired by the candidate word acquisition module 430.

In the apparatus 400, a communication message sent by a current contact in a communication application is acquired, a message type which matches the communication message is determined, and at least one candidate word for replying to the communication message in accordance with the determined message type is acquired. The apparatus provided by the embodiment solves the problem in the related conventional art that the efficiency for generating candidate words by an inputting method APP is low. The apparatus 400 further provides automatically generating at least one candidate word for replying to the communication message after the communication message is received. Accordingly, the number of operations required to be performed by the user in replying to the communication message can be reduced and the efficiency for generating candidate words can be improved, thereby facilitating improving the efficiency of replying to the communication message.

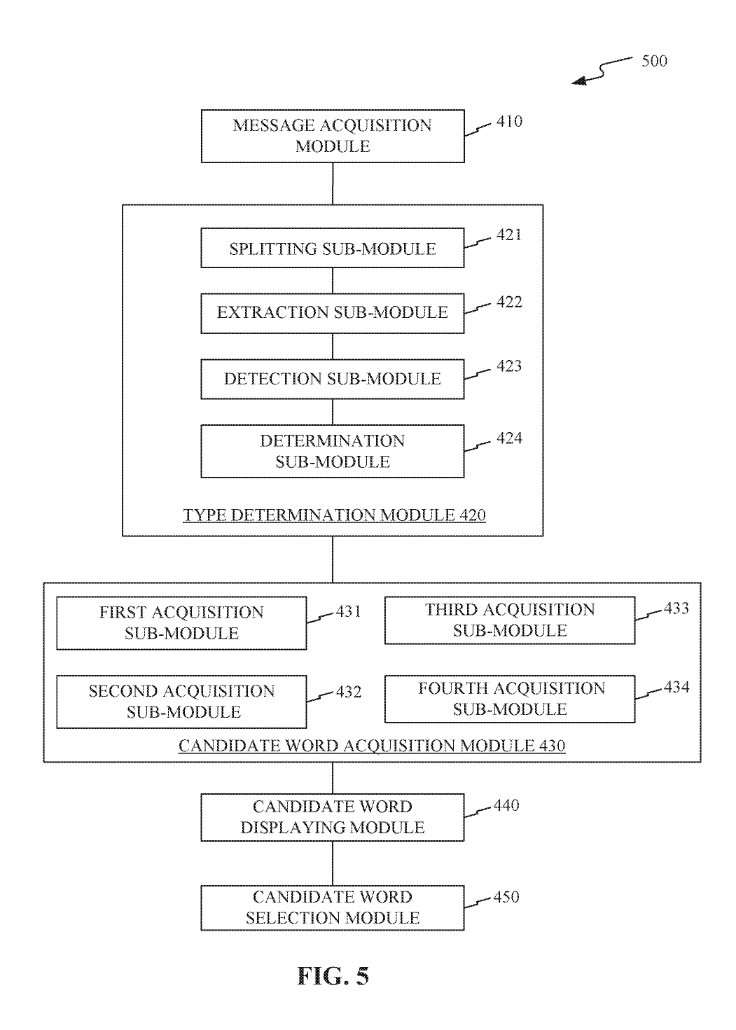

FIG. 5 is a block diagram of an apparatus 500 according to another exemplary embodiment. The apparatus 500 is capable of implementing the above methods by hardware or through running corresponding software. The apparatus 500 may comprises: a message acquisition module 410, a type determination module 420, a candidate word acquisition module 430, a candidate word displaying module 440, and a candidate word selection module 450.

The message acquisition module 410 is configured to acquire a communication message sent by a current contact in a communication application. The communication application is an application having a messaging function.

The type determination module 420 is configured to determine a message type which matches the communication message acquired by the message acquisition module 410.

The candidate word acquisition module 430 is configured to acquire at least one candidate word for replying to the communication message, in accordance with the message type which matches the communication message determined by the type determination module 420.

The candidate word displaying module 440 is configured to display the at least one candidate word acquired by the candidate word acquisition module 430.

In some embodiments, the type determination module 420 may comprise: a splitting sub-module 421, an extraction sub-module 422, a detection sub-module 423, and a determination sub-module 424.

The splitting sub-module 421 is configured to split the communication message into multiple semantic elements.

The extraction sub-module 422 is configured to extract a target semantic element from the communication message acquired by the splitting sub-module 421, in accordance with a message type to be matched.

The detection sub-module 423 is configured to detect whether the target semantic element extracted by the extraction sub-module 422 is included in a word library corresponding to the message type to be matched.

The determination sub-module 424 is configured to determine the message type as a message type which matches the communication message, when the detection sub-module 423 detects that the target semantic element is included in the word library corresponding to the message type to be matched.

In some embodiments, the extraction sub-module 422 is configured to determine a part-of-speech for each of the multiple semantic elements; and to extract the target semantic element from the communication message, in accordance with a semantic element extraction rule corresponding to the message type to be matched and the part-of-speech for each of the multiple semantic elements. The semantic element extraction rule prescribes a part-of-speech feature of the target semantic element to be extracted from the communication message.

In some embodiments, the candidate word acquisition module 430 may comprise a first acquisition sub-module 431.

The first acquisition sub-module 431 is configured to extract, from the communication message, a noun indicated by a target semantic element, when the message type which matches the communication message is a noun-selection type. The target semantic element is acquired by extracting from the communication message in accordance with the noun-selection type, and the at least one candidate word for replying to the communication message includes the noun.

In some embodiments, the candidate word acquisition module 430 may comprise a second acquisition sub-module 432.

The second acquisition sub-module 432 is configured to: extract a verb in the target semantic element, when the message type which matches the communication message is a verb-selection type, wherein the target semantic element is acquired by extracting from the communication message in accordance with the verb-selection type. The second acquisition sub-module 432 is further configured to determine, based on the verb, the at least one candidate word for replying to the communication message. The at least one candidate word for replying to the communication message includes at least one of the following: a positive tense form of the verb, a negative tense form of the verb, a perfect tense form of the verb and an imperfect tense form of the verb.

In some embodiments, the candidate word acquisition module 430 may comprise a third acquisition sub-module 433.

The third acquisition sub-module 433 is configured to: extract, from the communication message, a nearest verb from the target semantic element, when the message type which matches the communication message is a question type, wherein the target semantic element is acquired by extracting from the communication message in accordance with the question type. The third acquisition sub-module 433 is further configured to determine, based on the verb, the at least one candidate word for replying to the communication message. The at least one candidate word for replying to the communication message includes at least one of the following: a positive tense form of the verb, a negative tense form of the verb, a perfect tense form of the verb and an imperfect tense form of the verb.

In some embodiments the candidate word acquisition module 430 may comprise a fourth acquisition sub-module 434.

The fourth acquisition sub-module 434 is configured to acquire at least one preset candidate word corresponding to the target semantic element, when the message type which matches the communication message is a particular type. The target semantic element is acquired by extracting from the communication message in accordance with the particular type, and the at least one candidate word for replying to the communication message includes the at least one candidate word corresponding to the target semantic element.

In some embodiments the message acquisition module 410 is configured to acquire a communication message sent during a single chat session by the current contact in the communication application, or to acquire a communication message sent during a group chat session by the current contact in the communication application.

In some embodiments, the communication message is the last n communication messages sent by the current contact, wherein n is an integer equal to or greater than 1.

The candidate word selection module 450 is configured to receive a selection from the at least one candidate word being displayed and to write the selected candidate word into an input box.

In the apparatus 500, a communication message sent by a current contact in a communication application is received, a message type which matches the communication message is determined, and at least one candidate word for replying to the communication message in accordance with the determined message type is acquired. The apparatus 500 solves the problem in the related conventional art that the efficiency for generating candidate words by an inputting method APP is low. The apparatus further provides automatically generating at least one candidate word for replying to the communication message after the communication message is received Accordingly, the number of operations required to be performed by the user in replying to the communication message can be reduced and the efficiency for generating candidate words can be improved, thereby facilitating improving the efficiency of replying to the communication message.

Furthermore, by differentiating between message types and, setting different semantic element extraction rules and candidate word generation rules for different message types, respectively, accuracy and usability of the generated candidate words can be improved.

In addition, because a user may reply to the latest received one or more communication messages, generating corresponding candidate words based on the latest received one or more communication messages facilitates improving accuracy of the generated candidate words and better meeting the user's requirements.

According to an exemplary embodiment of the present disclosure, a message communicating apparatus capable of implementing a message communicating method according to the present disclosure is provided. The apparatus comprises: a processor; and a memory storing instructions executable by the processor. The processor is configured to: acquire a communication message sent by a current contact in a communication application, the communication application being an application with a messaging function; determine a message type which matches the communication message; acquire at least one candidate word for replying to the communication message, in accordance with the message type which matches the communication message; and display the at least one candidate word.

In some embodiments, the processor is configured to: split the communication message into multiple semantic elements; extract a target semantic element from the communication message, in accordance with a message type to be matched; detect whether the target semantic element is included in a word library corresponding to the message type to be matched; and determine the message type to be matched as a message type which matches the communication message, if the target semantic element is included in the word library corresponding to the message type in question

In some embodiments, the processor is configured to: determine a part-of-speech for each of the multiple semantic elements; and to extract the target semantic element from the communication message, in accordance with a semantic element extraction rule corresponding to the message type to be matched and the part-of-speech for each of the multiple semantic elements, wherein the semantic element extraction rule prescribes a part-of-speech feature of the target semantic element to be extracted from the communication message.

In some embodiments, the processor is configured to: extract, from the communication message, a noun indicated by a target semantic element, if the message type which matches the communication message is a noun-selection type. The target semantic element is acquired by extracting from the communication message in accordance with the noun-selection type, and the at least one candidate word for replying to the communication message includes the noun.

In some embodiments, the processor is configured to: extract a verb in a target semantic element, if the message type which matches the communication message is a verb-selection type, wherein the target semantic element is acquired by extracting from the communication message in accordance with the verb-selection type. The processor is further configured to determine, based on the verb, the at least one candidate word for replying to the communication message. The at least one candidate word for replying to the communication message includes at least one of the following: a positive tense form of the verb, a negative tense form of the verb, a perfect tense form of the verb and an imperfect tense form of the verb.

In some embodiments, the processor is configured to: extract, from the communication message, a nearest verb from a target semantic element, if the message type which matches the communication message is a question type, wherein the target semantic element is acquired by extracting from the communication message in accordance with the question type. The processor is further configured to determine, based on the verb, the at least one candidate word for replying to the communication message. The at least one candidate word for replying to the communication message includes at least one of the following: a positive tense form of the verb, a negative tense form of the verb, a perfect tense form of the verb and an imperfect tense form of the verb.

In some embodiments, the processor is configured to: acquire at least one preset candidate word corresponding to a target semantic element, if the message type which matches the communication message is a particular type. The target semantic element is acquired by extracting from the communication message in accordance with the particular type, and the at least one candidate word for replying to the communication message includes the at least one candidate word corresponding to the target semantic element.

In some embodiments, the processor is configured to: acquire a communication message sent during a single chat session by the current contact in the communication application; or acquire a communication message sent during a group chat session by the current contact in the communication application.

In some embodiments, the communication message is the last n communication messages sent by the current contact, wherein n is an integer equal to or greater than 1.

In some embodiments, the processor is configured to: receive a selection from the at least one candidate word being displayed, and to write the selected candidate word into an input box.

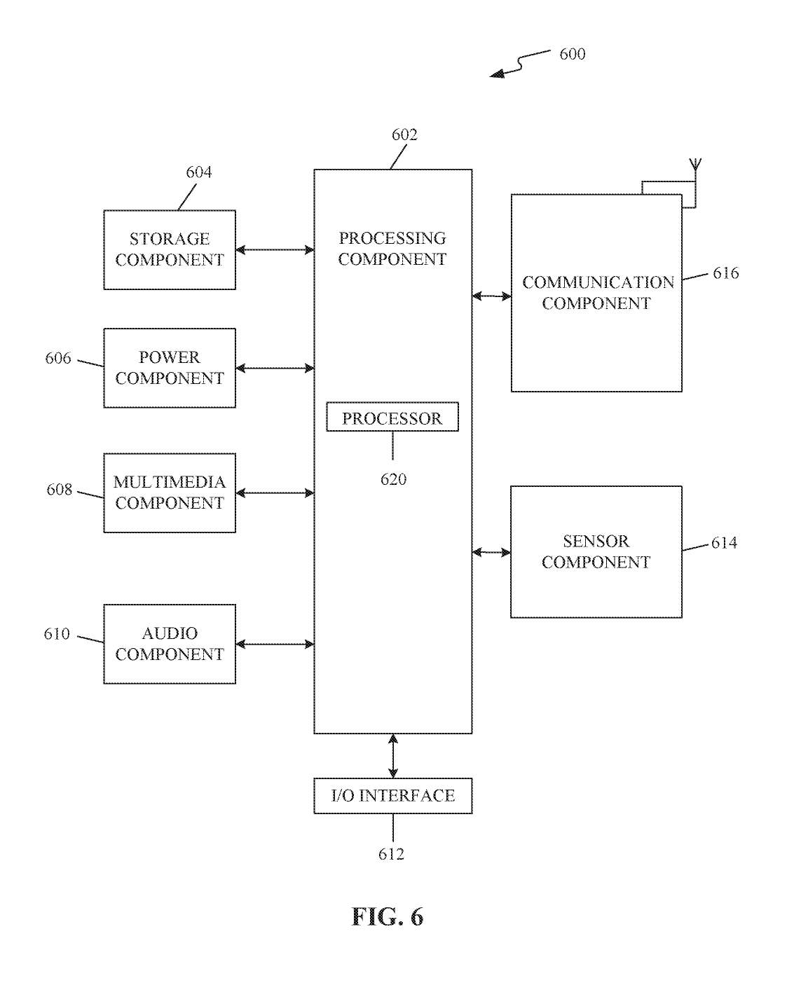

FIG. 6 is a block diagram of an apparatus 600 according to an exemplary embodiment. For example, the apparatus 600 may be a mobile phone, a computer, a digital broadcast terminal, a messaging device, a gaming console, a tablet, a medical device, exercise equipment, a personal digital assistant or the like.

Referring to FIG. 6, the apparatus 600 may include one or more of the following components; a processing component 602, a storage component 604, a power component 606, a multimedia component 608, an audio component 610, an input-output (I/O) interface 612, a sensor component 614 and a communication component 616.

The processing component 602 generally controls the overall operations of the apparatus 600, for example, display, phone call, data communication, camera operation and recording operation. The processing component 602 may include one or more processors 620 to execute instructions to perform all or part of the steps in the above described methods. In addition, the processing component 602 may include one or more modules to facilitate the interaction between the processing component 602 and other components. For example, the processing component 602 may include a multimedia module to facilitate the interaction between the multimedia component 608 and the processing component 602.

The storage component 604 is configured to store various types of data to support the operation performed on the apparatus 600. Examples of such data include instructions for any applications or methods operated on the apparatus 600, contact data, phonebook data, messages, pictures, video, etc. The storage component 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the apparatus 600. The power component 606 may include a power supply management system, one or more power sources, and any other components associated with the generation, management, and distribution of power in the apparatus 600.

The multimedia component 608 includes a screen providing an output interface between the apparatus 600 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive external multimedia data while the apparatus 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (“MIC”) configured to receive an external audio signal when the apparatus 600 is in an operation mode, such as a call mode, a recording mode, and a voice recognition mode. The received audio signal may be further stored in the storage component 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the apparatus 600. For instance, the sensor component 614 may detect an open/closed status of the apparatus 600, relative positioning of components, e.g., the display and the keypad, of the apparatus 600, a change in position of the apparatus 600 or a component of the apparatus 600, a presence or absence of user contact with the apparatus 600, an orientation or an acceleration/deceleration of the apparatus 600, and a change in temperature of the apparatus 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, a microwave sensor or a temperature sensor.

The communication component 616 is configured to facilitate wired or wireless communication between the apparatus 600 and other devices. The apparatus 600 can access a wireless network based on a communication standard, such as WiFi, 2G, or 3G, or a combination thereof. In one exemplary embodiment, the communication component 616 receives a broadcast signal or broadcast related information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 600 may be implemented with one or more application specific integrated circuits (ASIC), digital signal processors (DSP), digital signal processing devices (DSPD), programmable logic devices (PLD), field programmable gate arrays (FPGA), controllers, micro-controllers, microprocessors, or other electronic components, for performing the above described methods.

In exemplary embodiments, there is also provided a non-transitory computer-readable storage medium including instructions, such as included in the storage component 604, executable by the processor 620 of the apparatus 600, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the appended claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for message communication, comprising:
acquiring a communication message sent by a current contact in a communication application, the communication application having a messaging function;
determining a message type which matches the communication message;
acquiring at least one candidate word for replying to the communication message, in accordance with the message type; and
displaying the at least one candidate word.

2. The method according to claim 1, wherein determining the message type which matches the communication message comprises:
splitting the communication message into multiple semantic elements;
extracting a target semantic element from the communication message, in accordance with a message type to be matched;
detecting whether the target semantic element is included in a word library corresponding to the message type to be matched; and
determining the message type to be matched as the message type which matches the communication message, if the target semantic element is included in the word library corresponding to the message type to be matched.

3. The method according to claim 2, wherein extracting the target semantic element from the communication message in accordance with the message type to be matched comprises:
determining a part-of-speech for each of the multiple semantic elements; and
extracting the target semantic element from the communication message, in accordance with a semantic element extraction rule corresponding to the message type to be matched and the part-of-speech for each of the multiple semantic elements,
wherein the semantic element extraction rule prescribes a part-of-speech feature of the target semantic element to be extracted from the communication message.

4. The method according to claim 1, wherein acquiring at least one candidate word for replying to the communication message, in accordance with the message type, comprises:
extracting, from the communication message, a noun indicated by a target semantic element, if the message type is a noun-selection type, wherein the target semantic element is acquired by extracting from the communication message in accordance with the noun-selection type, and wherein the at least one candidate word for replying to the communication message includes the noun.

5. The method according to claim 1, wherein acquiring at least one candidate word for replying to the communication message, in accordance with the message type, comprises:
extracting a verb in a target semantic element, if the message type is a verb-selection type, wherein the target semantic element is acquired by extracting from the communication message in accordance with the verb-selection type; and
determining, based on the verb, the at least one candidate word for replying to the communication message,
wherein the at least one candidate word for replying to the communication message includes at least one of the following: a positive tense form of the verb, a negative tense form of the verb, a perfect tense form of the verb and an imperfect tense form of the verb.

6. The method according to claim 1, wherein acquiring at least one candidate word for replying to the communication message, in accordance with the message type, comprises:
extracting, from the communication message, a nearest verb from a target semantic element, if the message type is a question type, wherein the target semantic element is acquired by extracting from the communication message in accordance with the question type; and
determining, based on the verb, the at least one candidate word for replying to the communication message,
wherein the at least one candidate word for replying to the communication message includes at least one of the following: a positive tense form of the verb, a negative tense form of the verb, a perfect tense form of the verb and an imperfect tense form of the verb.

7. The method according to claim 1, wherein acquiring at least one candidate word for replying to the communication message, in accordance with the message type, comprises:
acquiring at least one preset candidate word corresponding to a target semantic element, if the message type is a particular type, wherein the target semantic element is acquired by extracting from the communication message in accordance with the particular type, and wherein the at least one candidate word for replying to the communication message includes the at least one preset candidate word corresponding to the target semantic element.

8. The method according to claim 1, wherein acquiring the communication message sent by the current contact in the communication application comprises performing at least one of:
acquiring the communication message sent during a single chat session by the current contact in the communication application; or
acquiring the communication message sent during a group chat session by the current contact in the communication application.

9. The method according to claim 1, wherein:
the communication message is last n communication messages sent by the current contact, wherein n is an integer equal to or greater than 1.

10. The method according to claim 1, further comprising:
receiving a selection from the at least one candidate word being displayed; and
displaying the selected candidate word in an input box.

11. A apparatus for message communication, comprising:
a processor; and
a memory storing instructions executable by the processor,
wherein the processor is configured to;
acquire a communication message sent by a current contact in a communication application, the communication application having a messaging function;
determine a message type which matches the communication message,
acquire at least one candidate word for replying to the communication message, in accordance with the message type; and
display the at least one candidate word.

12. The apparatus according to claim 11, wherein the processor is further configured to:
split the communication message into multiple semantic elements;
extract a target semantic element from the communication message, in accordance with a message type to be matched;
detect whether the target semantic element is included in a word library corresponding to the message type to be matched; and
determine the message type to be matched as the message type which matches the communication message, if the target semantic element is included in the word library corresponding to the message type to be matched.

13. The apparatus according to claim 12, wherein the processor is further configured to:
determine a part-of-speech for each of the multiple semantic elements; and
extract the target semantic element from the communication message, in accordance with a semantic element extraction rule corresponding to the message type to be matched and the part-of-speech for each of the multiple semantic elements,
wherein the semantic element extraction rule prescribes a part-of-speech feature of the target semantic element to be extracted from the communication message.

14. The apparatus according to claim 11, wherein the processor is further configured to:
extract, from the communication message, a noun indicated by a target semantic element, if the message type is a noun-selection type, wherein the target semantic element is acquired by extracting from the communication message in accordance with the noun-selection type, and wherein the at least one candidate word for replying to the communication message includes the noun.

15. The apparatus according to claim 11, wherein the processor is further configured to:
extract a verb in a target semantic element, if the message type is a verb-selection type, wherein the target semantic element is acquired by extracting from the communication message in accordance with the verb-selection type; and
determine, based on the verb, the at least one candidate word for replying to the communication message,
wherein the at least one candidate word for replying to the communication message includes at least one of the following: a positive tense form of the verb, a negative tense form of the verb, a perfect tense form of the verb and an imperfect tense form of the verb.

16. The apparatus according to claim 11, wherein the processor is further configured to:
extract, from the communication message, a nearest verb from a target semantic element, if the message type which matches the communication message is a question type, wherein the target semantic element is acquired by extracting from the communication message in accordance with the question type; and
determine, based on the verb, the at least one candidate word for replying to the communication message,
wherein the at least one candidate word for replying to the communication message includes at least one of the following: a positive tense form of the verb, a negative tense form of the verb, a perfect tense form of the verb and an imperfect tense form of the verb.

17. The apparatus according to claim 11, wherein the processor is further configured to:
acquire at least one preset candidate word corresponding to a target semantic element, if the message type is a particular type, wherein the target semantic element is acquired by extracting from the communication message in accordance with the particular type, and wherein the at least one candidate word for replying to the communication message includes the at least one preset candidate word corresponding to the target semantic element.

18. The apparatus according to claim 11, wherein the processor is further configured to perform at least one of:
acquiring the communication message sent during a single chat session by the current contact in the communication application; or
acquiring the communication message sent during a group chat session by the current contact in the communication application.

19. The apparatus according to claim 11, wherein:
the communication message is last n communication messages sent by the current contact, wherein n is an integer equal to or greater than 1.

20. A non-transitory computer-readable storage medium having stored therein instructions that, when executed by a processor of a mobile terminal, cause the mobile terminal to perform a message communicating method, the method comprising:
acquiring a communication message sent by a current contact in a communication application, the communication application having a messaging function;
determining a message type which matches the communication message;
acquiring at least one candidate word for replying to the communication message, in accordance with the message type; and
displaying the at least one candidate word.
